(19) United States
(12) Patent Application Publication
(10) Pub. No.: US 2013/0129905 A1
(43) Pub. Date: May 23, 2013

(54) NOVEL SOY-BASED INGREDIENTS AND USES THEREOF

(71) Applicant: Nicolas DEAK, St. Louis, MO (US)

(72) Inventor: Nicolas DEAK, St. Louis, MO (US)

(21) Appl. No.: 13/679,851

(22) Filed: Nov. 16, 2012

Related U.S. Application Data
(60) Provisional application No. 61/561,599, filed on Nov. 18, 2011.

(51) Int. Cl. A23L 1/308

(52) U.S. Cl. CPC A23L 1/3082
USPC 426/634; 426/656; 426/658

(57) ABSTRACT

The unique composition of a protein source remaining after producing an acid soluble protein that is heat stable and clear at acid pH allows for harvesting protein and non-protein ingredients with novel compositions and functionality. To this end, the invention is drawn to using a protein source remaining after producing an acid soluble protein that is heat stable and clear at acid pH for producing a novel protein composition and uses thereof.

### CROSS REFERENCE TO RELATED APPLICATIONS

This application claims priority from U.S. Provisional Application Ser. No. 61/561,599 filed Nov. 18, 2011.

### FIELD OF INVENTION

The present invention generally relates to a protein composition comprised of protein from a protein source that remains after an acid soluble protein that is heat stable and clear at acid pH is produced. More specifically the invention is drawn to vegetable protein compositions comprised of vegetable protein from a protein source that remains after an acid soluble protein that is heat stable and clear at acid pH is produced.

### BACKGROUND OF INVENTION

The soybean, Glycine max, is a leguminous crop grown in many parts of the world. Soybeans are of great economic importance as a source of edible oil, high-protein foods, food ingredients, and stockfeed, as well as many industrial products.

Soy proteins are typically in one of three forms when consumed by humans. These include flour (grits), concentrates, and isolates. All three types are made from defatted soybean flakes. Flours and grits contain at least 50% protein and are prepared by milling the flakes. Soy protein concentrates contain 65 wt. % to 90 wt. % protein on a dry weight basis, with the major non-protein component being fiber. Concentrates are made by repeatedly washing the soy flakes with water, which may optionally contain low levels of food grade alcohols or buffers. The effluent from the repeated washings is discarded and the solid residue is dried, thereby producing the desired concentrate. The yield of concentrates from the starting material is approximately 60-70%.

Soy protein isolates are the most highly refined soy protein products commercially available, as well as the most expensive. However, as with soy protein concentrates, many of the valuable minerals, vitamins, isoflavones, and phytoestrogens are drawn off to form a waste stream along with the low-molecular weight sugars in making the isolates. Soy protein isolates contain a minimum of 90% protein on a dry weight basis and little or no soluble carbohydrates or fiber. Isolates are typically made by extracting defatted soy flakes or soy flour with a dilute alkali (pH <9) and centrifuging. The extract is adjusted to pH 4.5 with a food grade acid such as sulfuric, hydrochloric, phosphoric or acetic acid. At a pH of 4.5, the solubility of the proteins is at a minimum so they will precipitate out. The protein precipitate is then dried after being adjusted to a neutral pH or is dried without any pH adjustment to produce the soy protein isolate. The yield of the isolate is 30% to 50% of the original soy flour and 60% of the protein in the flour. This extremely low yield along with the many required processing steps contributes to the high costs involved in producing soy protein isolates.

In manufacturing acid soluble soy protein that is heat stable and clear at acid pH, the spent flake remaining after recovery of the acid soluble soy protein that is heat stable and clear at acid pH is typically discarded. On a commercial scale, considerable costs are incurred with the handling and disposing of this spent flake. Thus, on a commercial scale, significant volumes of the spent flake are generated that must be discarded. In addition, it has been observed that the spent flake may contain a substantial proportion of the total protein content of the soybeans used in preparation of the acid soluble soy protein that is heat stable and clear at acid pH. Thus, a significant fraction of soy protein is typically discarded during production of acid soluble soy protein that is heat stable and clear at acid pH.

Thus, there is a need in the art for a process that can be used to recover the non-acid soluble protein and other products from the spent flakes when an acid soluble soy protein that is heat stable and clear at acid pH is manufactured.

### SUMMARY OF INVENTION

The present invention is to a protein composition comprising protein from a protein source remaining after producing an acid soluble protein that is heat stable and clear at acid pH and the process for making it. The protein can be a plant or animal based protein. In one embodiment the protein composition is a calcium-enriched protein composition.

The invention further includes a fiber-rich food ingredient composition comprised of fiber from a protein source remaining after producing an acid soluble protein that is heat stable and clear at acid pH and the process for making it. In one embodiment, the fiber-rich food ingredient is a calcium-enriched, fiber-rich food ingredient. When soy protein is the vegetable protein used, the fiber-rich food ingredient is also glycinin rich.

### BRIEF DESCRIPTION OF DRAWINGS

FIG. 1. Extraction of spent flakes.

FIG. 2. Preferential beta-conglycinin extraction from spent flakes.

FIG. 3. Enhanced protein extraction from spent flakes.

### DETAILED DESCRIPTION OF INVENTION

The unique composition of a protein source remaining after producing an acid soluble protein that is heat stable and clear at acid pH (including, for example, using process described in U.S. Pre-Grant Publication Nos. 20100215830, 20100215830, 20100203205, 20100203204, 20100179305, 20100098818, and 20050255226; all of which are incorporated herein by reference by their entirety) allows for harvesting protein and non-protein ingredients with novel compositions and functionality. For example, a protein source remaining after a process comprising using calcium chloride or other calcium salt to cause solubilization of protein from the protein source and to form an aqueous protein solution has high protein content, high fiber content, high calcium content, and most of the lipids and other components as originally present in the protein source.

In certain aspects of the invention, the unique composition of a soy protein source remaining after producing an acid soluble soy protein that is heat stable and clear at acid pH, wherein the process comprises, for example, using calcium chloride or other calcium salt to cause solubilization of soy protein from the soy protein source and to form an aqueous soy protein solution, allows for harvesting protein and non-protein ingredients with novel compositions and functionality. For example, a soy protein source remaining after a process comprising using calcium chloride or other calcium salt to cause solubilization of soy protein from the soy protein source and to form an aqueous soy protein solution has a high protein content (about 35-45%), high calcium content (about 4-7%), and most of the lipids and phytic acid as originally present in the soy protein source. Thus, the protein composition of this embodiment is calcium enriched when compared to current commercially available non-acid soluble protein compositions.

In certain aspects of the invention, the protein source is derived from a plant or animal. With regard to a vegetable protein source grown from a plant, the plant may be grown conventionally or organically. The plant may also be a naturally occurring plant or a genetically engineered plant. By way of non-limiting example, suitable vegetables may include leguminous plants, including soy, corn, peas, canola, sunflowers, sorghum, amaranth, potato, tapioca, arrowroot, canna, lupin, rape, oats, and mixtures thereof.

In particular aspects of the invention, the vegetable protein source is from soy. The soy protein source may be soybeans or any soy product or by-product derived from the processing of soybeans including, for example, soy meal, soy spent flakes, soy grits, and soy flour. In further particular aspects of the invention, the soy protein source is spent flakes from a process producing an acid soluble soy protein that is heat stable and clear at acid pH. The soy protein source may be used in the full-fat form, partially defatted form, or fully defatted form. The soy protein recovered from the soy protein source may be the protein naturally occurring in soybean or naturally occurring or modified protein in soybean as a result of genetic engineering. In other aspects of the invention, the soy protein source can be from a soybean with naturally or genetically altered lipid profiles, including for example, high stearic, high oleic, mid oleic, low linolenic, and ultra low linolenic in order to further improve the flavor characteristics of the composition.

Using a soy protein source remaining after producing an acid soluble soy protein that is heat stable and clear at acid pH as a starting material facilitates harvesting different protein fractions by changing extraction conditions including, for example, quantity of water added, pH, temperature, and ionic strength, to produce soy protein ingredients with novel compositions and functionality.

In certain aspects of the invention, spent flakes from a process producing an acid soluble soy protein that is heat stable and clear at acid pH have a unique composition. For example, these spent flakes have a high amount of residual protein (35-45%) while also containing a significant amount of calcium 4-7% by weight. The protein composition produced will be non-acid soluble and calcium-enriched compared to current commercially available non-acid soluble protein compositions.

The spent flakes further contain high amounts of fiber. In some embodiments it is a calcium-enriched fiber. When soy is the starting material the fiber is also glycinin-enriched. Soy fiber from such spent flakes will have between about 5% and about 15% glycinin before the fiber is dried in any standard drying process known to those skilled in the art.

Unless otherwise noted, technical terms are used according to conventional usage. Definitions of common terms in food science and human nutrition may be found in, for example, Practical Handbook of Soybean Processing and Utilization, published by American Oil Chemists' Society, 1995 (ISBN-13: 978-0935315639); Food Proteins: Processing Applications, published by Wiley-VCH, 1999 (ISBN-13: 978-0471297857); Wiley Encyclopedia of Food Science and Technology, 4 Volume Set, 2nd Edition, published by Wiley-Interscience, 1999 (ISBN-13: 978-0471192855); Breakfast Cereals and How They are Made, 2nd Ed. Edited by R. B. Fast and E. F. Caldwell (Egan Press, 2000); Extruders in Food Applications by M. N. Riaz (CRC Press, 2000); Extrusion Cooking by C. Mercier, P. Linko and J. M. Harper (Am. Assoc. Cereal Chemists, 1989); and other similar technical references.

As used herein, “a” or “an” may mean one or more. As used herein when used in conjunction with the word “comprising,” the words “a” or “an” may mean one or more than one. As used herein “another” may mean at least a second or more. Furthermore, unless otherwise required by context, singular terms include pluralities and plural terms include the singular.

As used herein, “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

As used herein, “comprising” and all its forms and tenses (including, for example, comprise and comprised) is synonymous with “including,” “containing,” or “characterized by,” and is inclusive or open-ended language and does not exclude an additional, unrecited element, step, or ingredient. As used herein, “consisting” and all its forms and tenses (including, for example, consist and consisted) is closed language and excludes any element, step, or ingredient not specified. As used herein, “consisting essentially of” and all its forms and tenses limits the scope of the invention to the specified element, step, or ingredient and those that do not materially affect the basic and novel characteristic(s) of the claimed invention. Applicants note that certain embodiments recite the transitional phrase “comprising.” Wherever this transitional phrase has been recited, the transitional phrase consisting or consisting essentially of have also been contemplated by the inventors and form part of the invention.

As used herein, “soy material” is defined as a material derived from whole soybeans, which contains no non-soy derived additives. Such additives may, of course, be added to a soy material to provide further functionality or nutrient content. The term “soybean” refers to the species Glycine max, Glycine soja, any species that is sexually cross compatible with Glycine max, or other species known by one of ordinary skill in the art.

As used herein, “soy protein isolate” is used in the sense conventional to the soy protein industry. Specifically, a soy protein isolate is a soy material having a protein content of at least 90% soy protein on a moisture free basis. “Isolated soy protein”, as used in the art, has the same meaning as “soy protein isolate” as used herein and as used in the art. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

As used herein, “soy protein concentrate” is used in the sense conventional to the soy protein industry. Specifically, a soy protein concentrate is a soy material having a protein content of from 65% up to 90% soy protein on a moisture-free basis. Soy protein concentrate also contains soy cotyledon fiber, typically from 3.5% to 5% soy cotyledon fiber by weight on a moisture-free basis. A soy protein concentrate is formed from soybeans by removing the hull and germ of the soybean from the cotyledon, flaking or grinding the cotyledon and removing oil from the flaked or ground cotyledon, and separating the soy protein and soy cotyledon fiber from the carbohydrates of the cotyledon.

As used herein, “soy flour” means a particulate soy material containing less than 65% soy protein content by weight on a moisture free basis which is formed from dehulled soybeans and which has an average particle size of about 150 microns or less. A soy flour may contain fat inherent in soy or may be defatted.

### EXAMPLES

The examples are illustrative and are not meant to limit the present invention in any way and many changes that can be made without departing from the spirit and scope of the invention would be apparent to those skilled in the art.

### Example 1

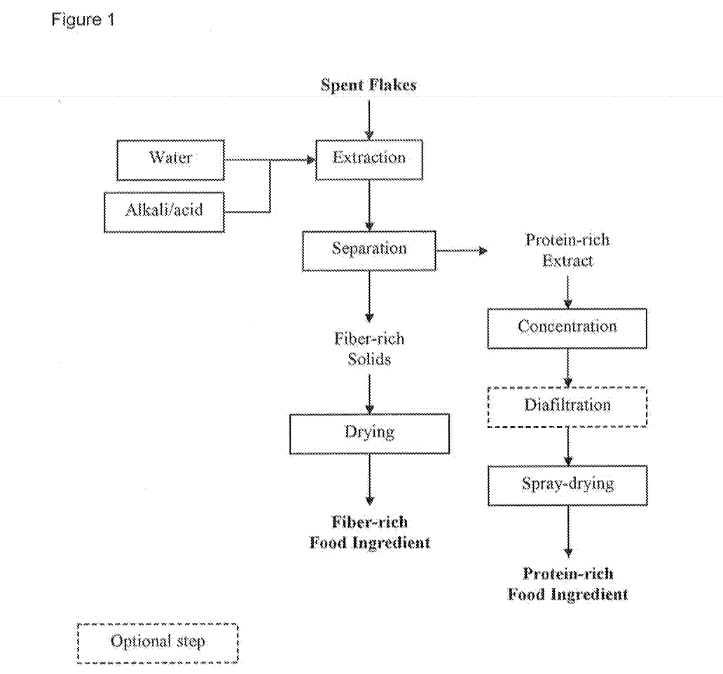

Extraction of spent flakes remaining after producing an acid soluble soy protein that is heat stable and clear at acid pH is illustrated in FIG. 1.

As described in FIG. 1, a spent flake is re-slurried with 10 parts of water to 1 part of solids contained in the spent flake and sufficient sodium hydroxide is added to obtain a pH of 7.5. The resultant alkaline slurry is extracted with, for example, a colloidal mill and then is centrifuged to separate a protein-rich extract and a fiber rich precipitate. The fiber rich precipitate is further dried in, for example, a forced air oven and then is ground to produce a fiber-rich food ingredient that is suitable for bakery applications due to, for example, very high water absorption and other attributes. Further, the resultant fiber product can be used for extrusion, for example, as a filler for meat adding texture to high moisture meat products.

The resultant protein extract is concentrated to a solids content of about 12% and then is optionally diafiltered until a dry weight basis protein content of 90% is achieved. Subsequently, the concentrated and diafiltered protein slurry is spray dried. The resultant protein ingredient has a high neutral solubility and is useful in neutral beverage applications or other food and beverage applications where it is desirable to use a protein ingredient with high neutral solubility.

### Example 2

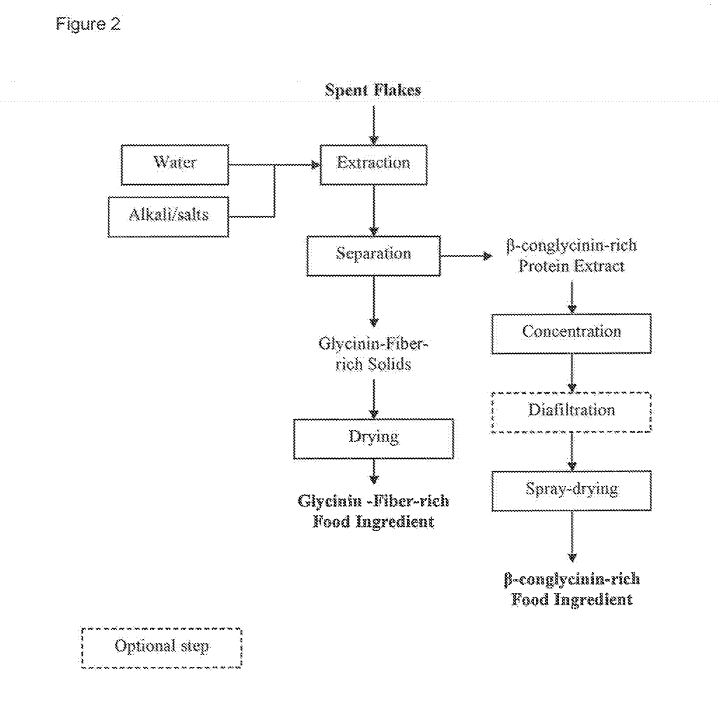

Preferential beta-conglycinin extraction from spent flakes remaining after producing an acid soluble soy protein that is heat stable and clear at acid pH is illustrated in FIG. 2.

The 7S fraction of soy protein comprises about 35% of the soluble protein. It contains some enzymes, a number of hemagglutinins, and a protein known as 7S globulin or β-conglycinin.

Spent flakes are re-slurried with 10 parts of water to 1 part of solids contained in the spent flake and sufficient sodium hydroxide is added to obtain a pH of 5.7. The resultant mildly acidic slurry is extracted with a colloidal mill and is then centrifuged to separate a β-conglycinin protein-rich extract and a glycinin-fiber rich precipitate. The glycinin-fiber-rich precipitate is further dried in a forced air oven and then is ground to produce a glycinin-fiber-rich food ingredient that is, for example, suitable for meat applications due to very high water absorption and gelling properties. Further, the resultant glycinin-fiber-rich food ingredient can be used for extrusion, for example, as a filler for meat products and also for bakery applications.

The resultant β-conglycinin-rich protein extract is concentrated to a solids content of about 12% and then optionally diafiltered until a dry weight basis protein content of 90% is achieved. Subsequently, the concentrated and diafiltered protein slurry is spray dried and the resultant β-conglycinin-rich food ingredient has neutral solubility and is useful in neutral beverage applications or other food and beverage applications where it is desirable to use a β-conglycinin-rich food ingredient with high neutral solubility. The β-conglycinin-rich food ingredient had a superior mouth feel and is suitable for confectionery and frozen dessert applications as well.

### Example 3

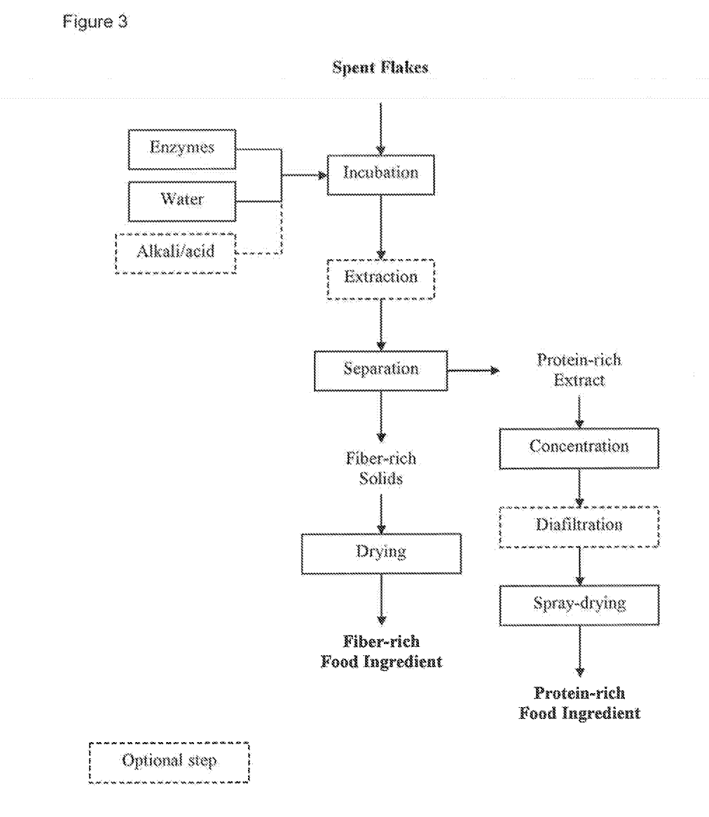

Enhanced protein extraction from a spent flake resulting from spent flakes remaining after producing an acid soluble soy protein that is heat stable and clear at acid pH is illustrated in FIG. 3.

Spent flakes are re-slurried with 10 parts of water to 1 part of solids contained in the spent flakes and sufficient sodium hydroxide was added as to obtain a pH of 7.5. The resultant alkaline slurry is treated with a mixture of different carbohydrase enzymes to improve protein extraction (including, for example, a hemicellulase, a cellulase, and a pectinase) for 30 minutes at 40° C. and subjected to mixture, extraction with a colloidal mill, and then is centrifugation to separate a protein-rich extract and a fiber-rich precipitate.

The fiber-rich precipitate is further dried in a forced air oven and then ground to produce a fiber-rich food ingredient that was suitable for bakery applications due to, for example, high water absorption. Further, the resultant fiber product can be used for extrusion, for example, as a filler for meat adding texture to high moisture meat products.

The resultant protein-rich extract is concentrated to a solids content of about 12% and then optionally diafiltered to concentrate the protein content to about 70%, in addition this fraction contains a partially hydrolyzed fraction of carbohydrates that gives this food ingredient novel functionality. Subsequently the concentrated and optionally diafiltered protein slurry is spray dried and the resultant protein ingredient has a high neutral solubility and is useful in, for example, confectionery, pudding, beverage and frozen dessert applications.

### Example 4

For illustration purposes, the protein ingredient of Example 1 is used in a neutral beverage application. The following Example illustrates the preparation of a dry blend containing the protein ingredient of Example 1. Ingredients are added to a vessel and mixed to form a dry blend.

TABLE 1

| Component | Parts by Weight | Grams per Serving |
|---|---|---|
| Protein Ingredient | 56.85 | 16.89 |
| Fructose | 20.23 | 6.01 |
| Sucrose | 20.22 | 6.01 |
| Dry Cream Extract | 1.01 | 0.30 |
| Ice Cream Vanilla Flavor | 1.35 | 0.40 |
| Sodium Chloride | 0.34 | 0.10 |
| Total | 100.00 | 29.71 |

A ready to drink beverage is prepared by adding a dry blend as prepared above. Order of addition of is of no importance. Within the ready to drink beverage, the liquid is present at from about 85% up to about 95% by weight of the total composition, and the pH of the ready to drink beverage is from about 6.8 up to about 7.4. The ready to drink beverage prepared by adding 29.71 grams of product to 240 ml liquid (including, for example, skim milk). The contents are blended for 30 seconds.

Other ingredients described herein, can also be used in a neutral beverage application.

### Example 5

For illustration purposes, the protein ingredient of Example 1 is used in a high protein food bar comprising the protein ingredient of Example 1 and sugar syrups.

To obtain the high protein food bars, a first mixture is produced in a Winkworth mixer (available from Winkworth Machinery, Ltd., Reading, England) mixing at a speed of 48 revolutions per minute (rpm) for one minute. The first mixture comprises: 600.0 grams the protein ingredient of Example 1, 32.4 grams rice syrup solids (available from Natural Products, Lathrop, Calif.), 76.4 grams cocoa powder (available from DeZaan, Milwaukee, Wis.), 10.5 grams vitamin & mineral premix (available from Fortitech®, Schenectady, N.Y.), and 1.6 grams salt.

In a separate container, a second mixture containing liquid sugar syrups and liquid flavoring agents is then heated to a temperature of 37.8° C. (100° F.) by microwaving on high power for about 45 seconds. The liquid sugar syrup consists of 710.0 grams of a 55:45 blend of 63 DE corn syrup (available from Roquette®, LESTREM Cedex, France) to high fructose corn syrup 55 (available from International Molasses Corp., Rochelle Park, N.J.) and 566.0 grams glycerin. The liquid flavoring agents consist of 4.1 grams Edlong® Chocolate flavor 610 (available from The Edlong® Corporation, Elk Grove Village, Ill.), 4.1 grams Edlong® Chocolate flavor 614 (available from The Edlong® Corporation, Elk Grove Village, Ill.), and 2.0 grams vanilla flavoring (available from Sethness Greenleaf, Inc., Chicago, Ill.). The heated second mixture is then mixed the first mixture in a Winkworth mixer at a speed of 48 rpm for three minutes and forty-five seconds. The resulting dough is then sheeted out onto a marble slab and bars are cut into pieces weighing from about 45 grams to about 55 grams (the bar pieces are 102 millimeters in length, 10 millimeters in height, and 35 millimeters wide).

Other ingredients described herein, can also be used in a high protein food bar.

### REFERENCES

All patents and publications mentioned in this specification are indicative of the level of those skilled in the art to which the invention pertains. All patents and publications herein are incorporated by reference to the same extent as if each individual publication was specifically and individually indicated as having been incorporated by reference in its entirety.

What is claimed:

1. A protein composition comprising protein from a protein source remaining after producing an acid soluble protein that is heat stable and clear at acid pH wherein the protein source is used to produce the protein composition.

2. The protein composition of claim 1, wherein the protein source is a vegetable protein source.

3. The protein composition of claim 2, wherein the vegetable protein source is selected from the group consisting of leguminous plants, soy, corn, peas, canola, sunflowers, sorghum, amaranth, potato, tapioca, arrowroot, canna, lupin, rape, oats, and mixtures thereof.

4. The protein composition of claim 3, wherein the vegetable protein source is from soy.

5. The protein composition of claim 4, wherein the protein from soy is from a soy spent flake.

6. The protein composition of claim 1, wherein the protein composition is a calcium-enriched protein composition.

7. The protein composition of claim 1, wherein the protein composition is selected from the group consisting of soy protein isolate, soy protein concentrate, soy flour, and combinations thereof.

8. The protein composition of claim 1, wherein the process for producing an acid soluble protein that is heat stable and clear at acid pH comprises a method using calcium chloride or other calcium salt to cause solubilization of protein from the protein source and to form an aqueous protein solution.

9. A process for producing a protein composition comprising protein from a protein source remaining after producing an acid soluble protein that is heat stable and clear at acid pH wherein the protein source is used to produce the protein composition.

10. The process of claim 9, wherein the protein source is a vegetable protein source.

11. The process of claim 10, wherein the vegetable protein source is selected from the group consisting of leguminous plants, soy, corn, peas, canola, sunflowers, sorghum, amaranth, potato, tapioca, arrowroot, canna, lupin, rape, oats, and mixtures thereof.

12. The process of claim 11, wherein the vegetable protein source is soy.

13. The process of claim 12, wherein the protein from soy is from a soy spent flake.

14. The process of claim 9, wherein the protein composition is a calcium-enriched protein composition.

15. The process of claim 9, wherein the protein composition is selected from the group consisting of soy protein isolate, soy protein concentrate, soy flour, and combinations thereof.

16. The process of claim 9, wherein the process for producing an acid soluble protein that is heat stable and clear at acid pH comprises a method using calcium chloride or other calcium salt to cause solubilization of protein from the protein source and to form an aqueous protein solution.

17. A fiber-rich food ingredient comprising fiber from a protein source remaining after producing an acid soluble protein that is heat stable and clear at acid pH wherein the protein source is used to produce the fiber-rich food ingredient.

18. The fiber-rich food ingredient of claim 17, wherein the protein source is a vegetable protein source.

19. The fiber-rich food ingredient of claim 18, wherein the vegetable protein source is selected from the group consisting of leguminous plants, soy, corn, peas, canola, sunflowers, sorghum, amaranth, potato, tapioca, arrowroot, canna, lupin, rape, oats, and mixtures thereof.

20. The fiber-rich food ingredient of claim 19, wherein the vegetable protein source is from soy.

21. The fiber-rich food ingredient of claim 20, wherein the protein from soy is from a soy spent flake.

22. The fiber-rich food ingredient of claim 20, wherein the fiber-rich food ingredient is a glycinin-rich fiber food ingredient.

23. The fiber-rich food ingredient of claim 17, wherein the fiber-rich food ingredient is a calcium-enriched, fiber-rich food ingredient.
